(19) United States
(12) Patent Application Publication
(10) Pub. No.: US 2010/0163335 A1
(43) Pub. Date: Jul. 1, 2010

(54) Loudspeaker enclosure

(76) Inventor: Peigen Jiang, Sammamish, WA (US)

Correspondence Address: PEIGEN JIANG, 19480 SE 28TH PLACE, SAMMAMISH, WA, 98075, US

(21) Appl. No.: 12/344,510

(22) Filed: Dec. 27, 2008

(51) Int. Cl. H04R 1/02

(52) U.S. Cl. 181/199

(57) ABSTRACT

A loudspeaker enclosure is disclosed which comprises a front baffle for mounting one or more loudspeaker drivers, an inner and an outer side panel bonded to the front baffle forming one side of the loudspeaker enclosure, the inner and the outer side panel not contacting each other, either the inner or the outer side panel independently enclosing the side of the loudspeaker enclosure, both the inner and the outer side panel being at least approximately one half inch in thickness, wherein vibration on the outer side panel is reduced.

### BACKGROUND

The present invention relates generally to loudspeakers, and, more particularly, to a loudspeaker enclosure structure.

One goal for better sound reproduction by loudspeakers employing dynamic drivers is to make the loudspeaker enclosure as inert as possible. Therefore, loudspeaker enclosures are typically made of dense materials such as medium-density-fiberboard (MDF) or aluminum. The loudspeaker enclosures are made very thick as well. As a result, some high-end loudspeakers weight as much as 700 pounds each.

Plywood is also traditionally used as loudspeaker enclosing building material. Even though plywood is easy to work with and quite rigid, it tends to have voids which are generally avoided for causing resonations.

Another way to make the loudspeaker enclosure more inert is to dampen the sound inside the loudspeaker enclosure as much as possible. However, dense materials such as MDF or aluminum are very poor damping materials. In order to kills off the unwanted sound inside the loudspeaker enclosures, some are made to have odd shaped or curved enclosures, and are lined with damping materials inside the enclosure. Such solutions make loudspeaker production more complicated and certainly add to the cost.

A U.S. Pat. No. 6,719,092 discloses a lightweight loudspeaker enclosure with sandwiched panels. While the weight can be reduced, but such sandwiched panel structure is complicated to manufacture, does not have adequate mass to remain inert in bass sound impact.

As such, what is desired is loudspeaker enclosure that has good external inert characteristic yet easy to manufacture.

### SUMMARY

A loudspeaker enclosure is disclosed which comprises a front baffle for mounting one or more loudspeaker drivers, an inner and an outer side panel bonded to the front baffle forming one side of the loudspeaker enclosure, the inner and the outer side panel not contacting each other, either the inner or the outer side panel independently enclosing the side of the loudspeaker enclosure, both the inner and the outer side panel being at least approximately one half inch in thickness, wherein vibration on the outer side panel is reduced.

The construction and method of operation of the invention, however, together with additional objects and advantages thereof, will be best understood from the following description of specific embodiments when read in connection with the accompanying drawings.

### BRIEF DESCRIPTION OF THE DRAWING

FIG. 1 is a perspective view of a typical loudspeaker enclosure.

FIG. 2 is a cross-sectional view of a loudspeaker enclosure structure according to one embodiment of the present invention.

The drawings accompanying and forming part of this specification are included to depict certain aspects of the invention. A clearer conception of the invention, and of the components and operation of systems provided with the invention, will become more readily apparent by referring to the exemplary, and therefore non-limiting, embodiments illustrated in the drawings, wherein like reference numbers (if they occur in more than one view) designate the same elements. The invention may be better understood by reference to one or more of these drawings in combination with the description presented herein. It should be noted that the features illustrated in the drawings are not necessarily drawn to scale.

### DESCRIPTION

The following will provide a detailed description of a loudspeaker enclosure, the side panel of which is formed by two separated layers of dense materials with substantial thickness for reducing the enclosure vibration.

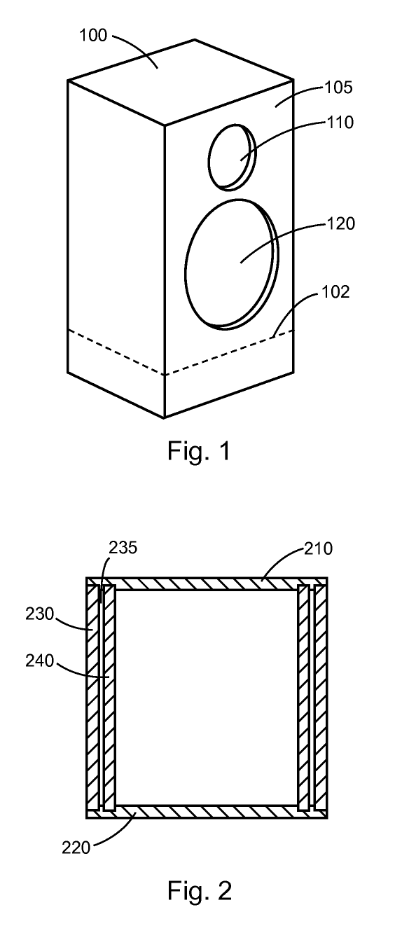

FIG. 1 is a perspective view of a typical loudspeaker enclosure 100. The loudspeaker enclosure 100 is essentially an enclosed box except two driver openings 110 and 120 in the front baffle 105. The opening 110 is typically for mounting a tweeter. The opening 120 is typically for mounting a woofer. In an ideal operating condition, sound should come from the drivers themselves with the enclosure 100 producing little or no sound at all.

FIG. 2 is a cross-sectional view of the loudspeaker enclosure structure 100 according to one embodiment of the present invention. The cross-section is taken at a position marked by a doted line 102 in FIG. 1. The cross-section shows that the loudspeaker enclosure 100 of FIG. 1 is enclosed by panels on all four sides. A front baffle 220 and a back panel 210 are single layer panels typically made of sense medium-density-fiberboard (MDF) of substantial thickness of a half inch or thicker. In high performance loudspeakers, the front baffle 220 is typically more than one inch thick. The sides of the exemplary loudspeaker enclosure 100 as shown in FIG. 2 are symmetrical with each side having two separated panels 230 and 240. The two separated panels 230 and 240 are bonded to the front baffle 220 and the back panel 210 and maintain a small gap 235 in between. Either the inner side panel 240 or the outer side panel 230 independently encloses the side of the loudspeaker enclosure 100. Vibration on the inner side panel 240 can only ripple to the outer side panel 230 through the air trapped in the gap 235 and the small portions of the front baffle 220 and back panel 210 that bond the side panels 230 and 240. The width of the gap 235 is not critical as it need not be filled. For making the loudspeaker enclosure 100 less bulky, the gap 235 can be as small as one eighth of an inch. A key to the effectiveness in preventing unwanted sound from radiating out of the loudspeaker structure 100 of the present invention is that the outer side panel 230 must have enough density and thickness to block sound in the gap 235 from vibrating out of the outer panel 230. The thickness of the outer panel 230 should be at least one half inch in thickness and at least as dense as wood or plywood. The thicker and the denser the outer panel 230 is, the better a sound barrier the loudspeaker enclosure 100 can be. For the same reason, the inner panel 240 is also the thicker and the denser the better. In practice, the inner panel 240 should be at least one half inch in thickness, and made of MDF. A skilled artisan may also realize that present invention is not limited to just double panels, additional panels structured similarly to the inner panel 240 and the outer panel 230 will provide additional sound barrier effect.

The loudspeaker enclosure structure 100 of the present invention providing a gap 235 between two side panels 230 and 240 is counter conventional, as any void in an enclosure panel is considered prone to resonation and coloring the sound reproduction. The present invention utilize thick side panels 230 and 240, any resonation in the gap 235 is blocked by the outer side panel 230. The thick internal panel 240 is also less vibratory. The side panels 230 and 240 being bonded directly to the front baffle 220 and the back panel 210 as shown in FIG. 2 makes the manufacturing of such loudspeaker enclosure 100 easier. Making the outer side panel 230 parallel to the inner side panel 240 apparently makes the manufacturing easier though this is not required for any acoustic performance.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

1. A loudspeaker enclosure comprising:
a front baffle for mounting one or more loudspeaker drivers;
a back panel opposite to the front baffle; and
an inner and an outer side panel bonded to both the front baffle and the back panel forming one side of the loudspeaker enclosure, the inner and the outer side panel not contacting each other, either the inner or the outer side panel independently enclosing the side of the loudspeaker enclosure, both the inner and the outer side panel being at least approximately one half inch in thickness.

2. The loudspeaker enclosure of claim 1, wherein the inner and the outer side panel are in parallel.

3. The loudspeaker enclosure of claim 2, wherein a gap between the inner and outer side panel is less than a quarter inch wide.

4. The loudspeaker enclosure of claim 1, wherein both the inner and the outer side panel are made of medium-density-fiberboard (MDF).

5. The loudspeaker enclosure of claim 1, wherein the outer side panel is made of plywood.

6. (canceled)

7. A loudspeaker enclosure comprising:
a front baffle for mounting one or more loudspeaker drivers;
a rear baffle opposite to the front baffle; and
an inner and an outer side panel bonded to both the front baffle and the back panel forming one side of the loudspeaker enclosure, the inner and the outer side panel not contacting each other, either the inner or the outer side panel independently enclosing the side of the loudspeaker enclosure, both the inner and the outer side panel being at least approximately one half inch in thickness and being made of medium-density-fiberboard (MDF).

8. The loudspeaker enclosure of claim 7, wherein the inner and the outer side panel are in parallel.

9. The loudspeaker enclosure of claim 8, wherein a gap between the inner and outer side panel is less than a quarter inch wide.

10-11. (canceled)
